(19) United States
(12) Patent Application Publication
(10) Pub. No.: US 2022/0161634 A1
(43) Pub. Date: May 26, 2022

(54) VENTILATION SYSTEM

(71) Applicant: NOVARES LÖHNE GMBH, Lohne (DE)

(72) Inventors: Viktor SCHMIDT, Bad Oeynhausen (DE); Daniel BUELTEMEIER, Lohne (DE); Peter HAMKE, Lohne (DE)

(21) Appl. No.: 17/456,203

(22) Filed: Nov. 23, 2021

(30) Foreign Application Priority Data
Nov. 24, 2020 (DE) 10 2020 131 095.1

(51) Int. Cl. B60H 1/34

(52) U.S. Cl. CPC B60H 1/3428; B60H 2001/00721

(57) ABSTRACT

A ventilation device of a motor vehicle includes a housing having an inlet opening and an outlet opening. A guide unit is arranged between the inlet and outlet openings and includes a number of guide surfaces forming air ducts. A control element arranged between the inlet opening and the guide unit adjusts a volumetric flow ratio of an air flow flowing along the guide unit. The control element has a partially cylindrical air duct body is arranged in the housing such that it can be pivoted about a first pivot axis perpendicular to the inflow direction. A number of slats are coupled to one another and are pivotable about respective second pivot axes perpendicular to the first pivot axis are arranged in the air duct body. The air duct body and the slat unit are adjustable independently of one another by an adjusting unit.

### CROSS-REFERENCE TO RELATED APPLICATIONS

This application claims priority under 35 U.S.C. 119 to German patent application number 10 2020 131 095.1, filed Nov. 24, 2020, the entire disclosure of which is herein expressly incorporated by reference.

### BACKGROUND AND SUMMARY OF THE INVENTION

Exemplary embodiments of the present invention relate to a ventilation device of a motor vehicle for regulating or changing an outflow direction of air exiting the ventilation device.

Such ventilation devices, for example known from DE 10 2013 210 053 B3, are used to introduce air into a passenger compartment of a motor vehicle. The air can be preheated or precooled in advance to heat or cool the passenger compartment with the aid of a heater or an air conditioning module.

Such ventilation devices are usually installed in a dashboard or instrument panel of the motor vehicle. The direction of the outflow of air can be varied using control elements.

The variation of the outflow direction is usually achieved by arranging a plurality of slats, which are attached to a housing of the ventilation device, close to the outlet opening and can be aligned by means of adjusting elements.

In the ventilation device as known from the above-mentioned DE 10 2013 210 053 B3, the slats are not installed in the region of the outlet opening, but in a rear region of a housing of the ventilation device remote from the outlet opening. In this case, the housing is formed with curved air guiding surfaces which are curved in such a way that air flows guided through the ventilation device from an air inlet opening to the air outlet opening collide with each other in a region of the passenger compartment in front of the outlet opening and thus, depending on the quantity of the volumetric flow guided through different air ducts, a resulting air flow is obtained which, in the case of volumetric flows of the same size through all air ducts, results in an air flow directed in the direction of a longitudinal axis of the air ejector.

If this volumetric flow is reduced in an upper air duct, for example, this results in an upwardly directed volumetric flow. Deflection vanes within these air ducts serve to be able to produce a deflection of the volumetric flow in the direction perpendicular to the longitudinal axis of the air ejector.

The problem with such ventilation devices is that the range of the air flow, also referred to as the throw range, is very limited due to the turbulence of the air in front of the air outlet opening in the area of the passenger compartment, so that the rear of the passenger compartment in particular cannot be cooled or heated sufficiently quickly.

Exemplary embodiments of the present invention are directed to a ventilation device permitting a greater throw range of the outflowing air into the passenger compartment, with a simultaneous arrangement of slats for controlling the air flow in a rear region of the ventilation device.

The ventilation device according to the invention has a housing with an air inlet with an inlet opening and an air outlet with an outlet opening, which is open towards a passenger compartment of the motor vehicle.

The ventilation device further comprises a guide unit arranged between the inlet opening and the outlet opening in the housing and having a plurality of guide elements forming air ducts.

A control element is arranged in the housing between the inlet opening and the guide unit, which enables the adjustment of a volumetric flow ratio of an air flow flowing along the guide unit.

The ventilation device further comprises an adjusting unit for adjusting the control element.

The control element comprises a partially cylindrical air duct body arranged in the housing so as to be pivotable about a first pivot axis perpendicular to the inflow direction.

A slat unit is arranged in the air duct body having a plurality of slats which, viewed in the inflow direction, are arranged next to one another, are coupled to one another and can be pivoted about a respective second pivot axis perpendicular to the first pivot axis.

The air duct body and the slat unit can be adjusted independently of each other by actuating the adjusting unit.

With a ventilation device arranged in this manner a reliable regulation and change of the outflow direction of the air exiting the ventilation device is ensured without the kinematics for regulating or changing the outflow direction being visible to the driver or the passenger.

Furthermore, such a ventilation device enables a variable design of a panel for covering the ventilation device, so that design specifications within the passenger compartment of the motor vehicle, for example to intended curve shapes of instrument panels, can be implemented in a simple manner.

The arrangement of the control element behind the guide unit, in which an air flow first flows through the control element and then through the guide unit, also enables an increased throw range of the outflowing air, so that the rear of a passenger compartment can also be heated or cooled quickly and reliably.

According to an advantageous embodiment variant, regions of the inner side walls of the housing close to the outlet opening are shaped in such a way that the width of the inner space of the housing tapers towards the outlet opening.

This enables a further increase in the throw range of the outflowing air.

The areas of the inner side wall of the housing close to the outlet opening are preferably shaped as concavely curved guide surfaces.

According to an advantageous embodiment variant, the air duct body comprises a barrier wall for blocking an air flow from the inlet opening in the direction of the guide unit. This allows in a simple way a complete closure of the flow ducts.

According to a further advantageous embodiment variant, the slat unit has a centrally arranged slat with flat guide surfaces on both sides and in each case at least one slat arranged laterally of the central slat with angularly bent guide surfaces, wherein the bent slats are bent away from the central slat in a neutral position in a rear region behind the second axis of rotation in the direction of flow.

This enables a reliable closing of a part of the air ducts with a relatively small adjustment angle and secondly an advantageous redirection of the air flowing in through the inlet opening into the open flow ducts.

According to one embodiment variant, the adjusting unit is designed as a touchscreen, acoustic, or optical unit, which is coupled to at least one servomotor driving the slat unit and/or the air duct body.

This allows a very simple intuitive adjustment of the air flow in a desired discharge direction.

According to a further advantageous embodiment variant, the adjusting unit is coupled to the air duct body via an air duct body adjusting element with which the air duct body can be adjusted so as to be pivotable about the first pivot axis.

Further preferably, the adjusting unit is coupled to the slat unit via a slat adjusting element with which the slat unit is pivotally adjustable about the second pivot axis.

According to a preferred further development, the adjusting unit comprises an adjusting element coupled to the slat adjusting element and the air duct body adjusting element for adjusting the air duct body and the slat unit.

This makes it possible to adjust the air flow in different discharge directions in a user-friendly manner with a single control element.

According to an advantageous further development, the adjusting element is cylindrical and can be displaced in the longitudinal direction of the cylinder at the side of the outlet opening on the housing and is rotatably mounted in the circumferential direction of the cylinder.

For ease of operation, according to a further preferred embodiment, the adjusting unit has an operating element fixed to the adjusting element.

According to a further advantageous embodiment variant, the guide unit comprises an upper part and a lower part each having guide webs projecting from a convexly curved guide surface in the direction of the housing.

In a preferred further development, a central guide body with convexly curved guide surfaces protrudes from each of the upper part and the lower part in the direction of the housing.

According to an advantageous embodiment variant, the guide unit together with the housing surrounding it forms a plurality of curved guide air ducts.

In a further advantageous embodiment variant, an illumination unit is defined in a cavity formed between the upper part and the lower part of the guide unit.

### BRIEF DESCRIPTION OF THE DRAWING FIGURES

Preferred exemplary embodiments are described in more detail below with reference to the accompanying drawings, wherein:

FIG. 1 shows a front view of an embodiment variant of a ventilation device according to the invention,

FIG. 2 shows a top view of the ventilation device of FIG. 1,

FIG. 3 shows an exploded view of the ventilation device shown in FIG. 1,

FIG. 4 shows an isometric detailed view of a second housing part,

FIG. 5 shows an isometric exploded view of an embodiment variant of a guide unit of the ventilation device having an illumination unit arranged therebetween,

FIG. 6 shows an isometric view of the adjusting unit of the coupling element of the slat adjusting element, the air duct body adjusting element and two coupling elements,

FIG. 7 shows an isometric representation of the control element and the slat unit,

FIG. 8 shows an isometric view of the control element and the slat unit from another perspective,

FIG. 9A shows a side view of the ventilation device in a neutral position of the operating element and neutral position of the air duct body adjusting element for deflecting the air flow in the vertical direction,

FIG. 9B shows a sectional view through a vertical center plane of the ventilation device to show the neutral position of the air duct body,

FIGS. 10A and 10B show representations corresponding to FIGS. 9A and 9B with the operating element pivoted upwards to upwardly direct the outflowing air flow into the passenger compartment,

FIGS. 11A and 11B show representations corresponding to FIGS. 9A and 9B with the operating element pivoted downwards to downwardly deflect the outflow direction of the air flow into the passenger compartment,

FIGS. 12A and 12B show representations corresponding to FIGS. 9A and 9B with the operating element pivoted in a closed position,

FIG. 13 shows a sectional view of the ventilation device through a horizontal central plane with the operating element and slats positioned in a neutral position,

FIG. 14 shows a representation corresponding to FIG. 13 with pivoted slats to deflect the outflow direction to the left,

FIG. 15 shows a representation corresponding to FIG. 14 with slats in a position to deflect the outflow direction into the passenger compartment to the right, and

FIGS. 16A-16D shows cross-sectional views of the ventilation device through a vertical plane along an adjusting lever of the slat adjusting element at different positions of an air duct body of a control element.

### DETAILED DESCRIPTION

In the following figure description, terms such as top, bottom, left, right, front, rear, etc. refer exclusively to the exemplary representation and position of the ventilation device, housing, guide unit, control element, slat unit, adjusting unit and the like selected in the respective figures. These terms are not to be understood restrictively, i.e., due to different working positions or the mirror-symmetrical design or the like, these references may change.

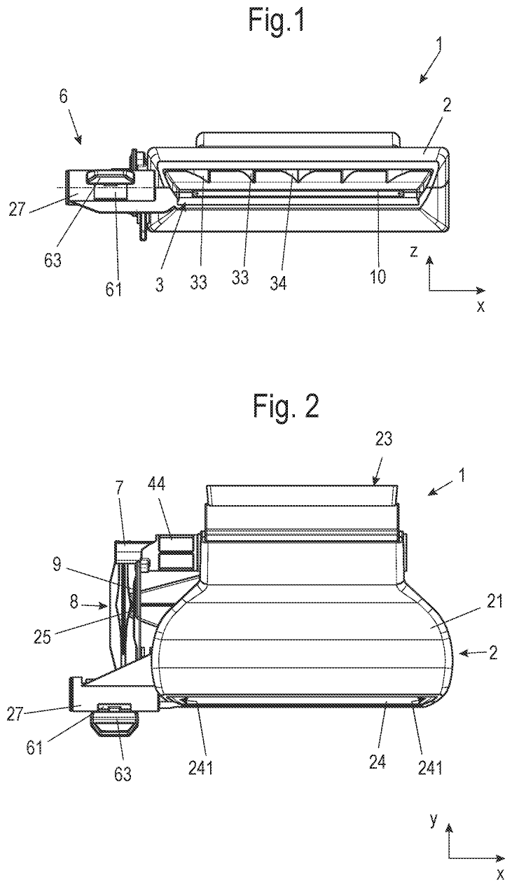

In FIGS. 1 and 2, the reference sign 1 altogether denotes an embodiment variant of a ventilation device of a motor vehicle according to the invention for regulating and changing an outflow direction A of air exiting the ventilation device 1.

As shown in FIGS. 1 and 2, the ventilation device 1 has a housing 2 having an air inlet with an inlet opening 23 and an air outlet open towards a passenger compartment of the motor vehicle with an outlet opening 24. Through the inlet opening 23, air from a heating device can be preheated or an air conditioning device can be precooled and blown into the ventilation device 1.

In the area in front of the outlet opening 24, an orifice may be arranged (not shown here).

Between the inlet opening 23 and the outlet opening 24, a guide unit 3 having a plurality of guide surfaces 35 and guide webs 33, 34 forming air ducts is arranged in the housing 2. Furthermore, a control element 4 is arranged between the inlet opening 23 and the guide unit 3 in the housing 2, which serves to adjust a volumetric flow ratio of an air flow flowing along the guide unit 3.

Furthermore, the ventilation device 1 comprises an adjusting unit 6, which is used to adjust the control element 4.

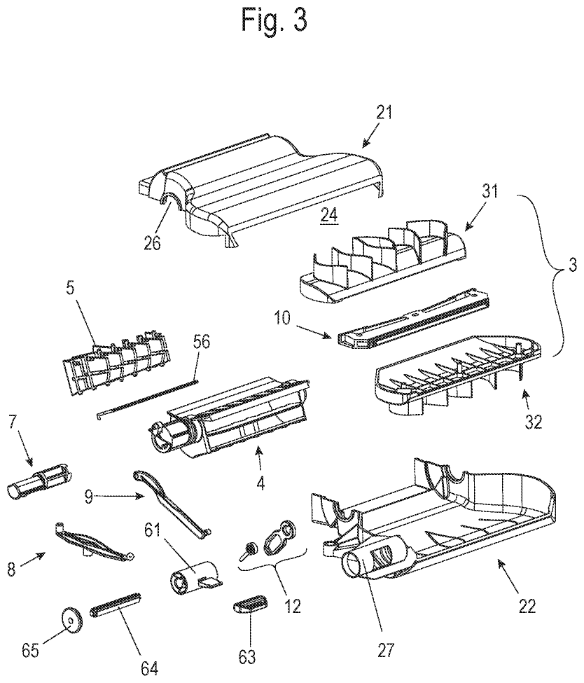

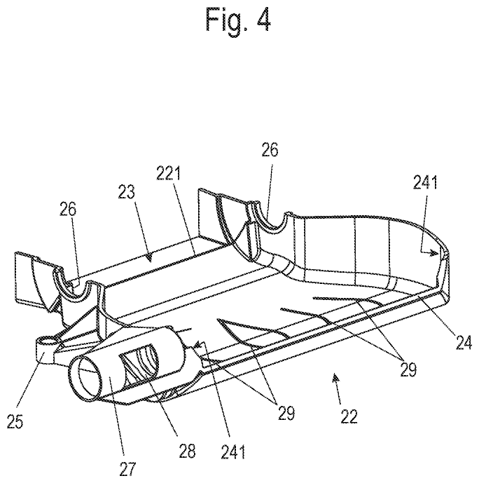

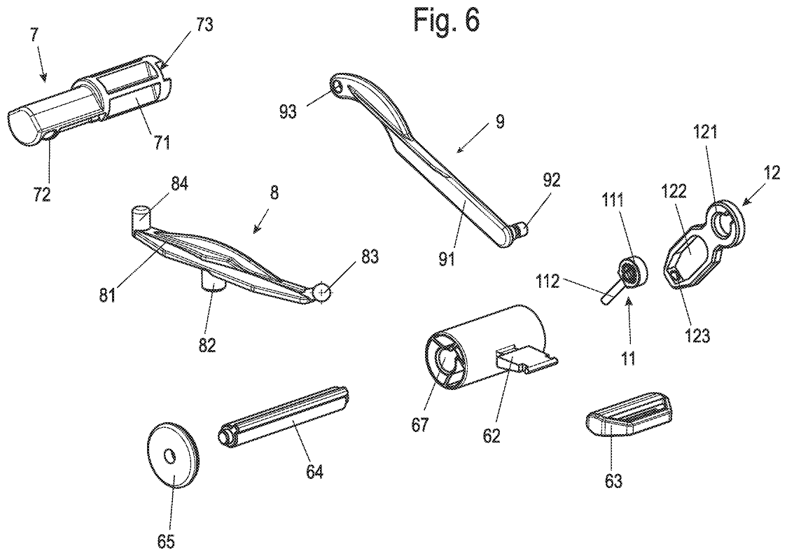

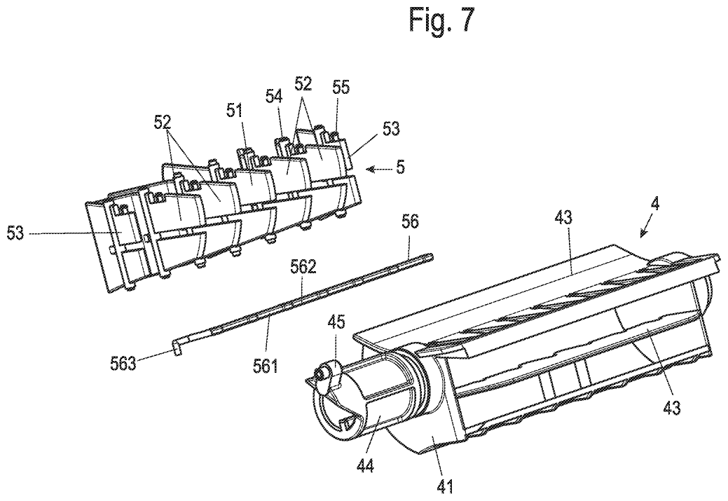

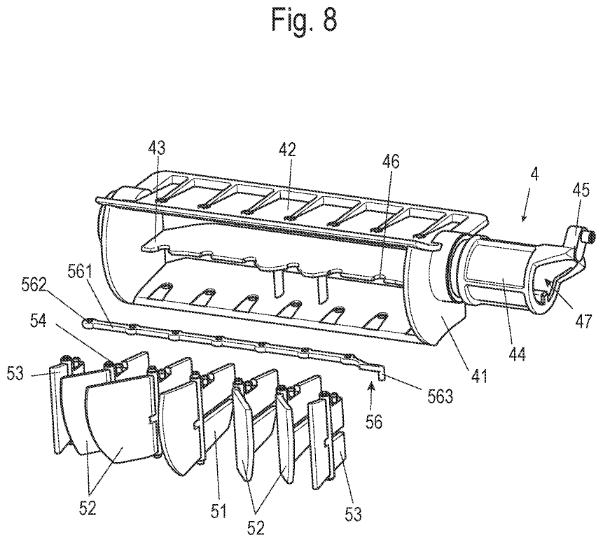

As can be seen in particular from FIGS. 3 to 8 and 9A, the control element 4 comprises a partially cylindrical air duct body 41 arranged in the housing 2 so as to be pivotable about a first pivot axis S1 perpendicular to the inflow direction E. In this air duct body 41, shown in detail in FIGS. 7 and 8, a slat unit 5 is arranged.

The slat unit 5 has a plurality of slats 51, 52, 53 arranged side by side as viewed in the inflow direction E, coupled to one another and pivotable about respective second pivot axes 54 perpendicular to the first pivot axis S1.

The air duct body 41 and the slat unit 5 are designed to be adjustable independently of each other by actuating the adjusting unit 6.

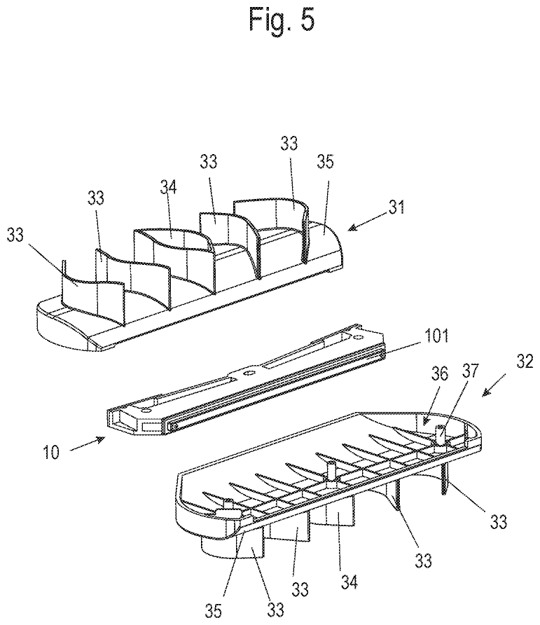

As can be seen in particular from FIGS. 3 and 5, the guide unit 3 in the preferred embodiment shown here is composed of an upper part 31 and a lower part 32. Both the upper part 31 and the lower part 32 have respective guide surfaces 35 which are convexly curved out of an imaginary horizontal plane and from which guide webs 33, 34 project perpendicularly in the direction of the housing 2.

An integral design of the guide unit is also conceivable or a guide unit assembled in another way with, for example, front and rear parts or right and left parts in the direction of flow.

The guide unit 3, together with the housing 2 surrounding it, forms a plurality of curved guide air ducts. The curvature of the guide webs is such that they are capable of deflecting an air flow in a predetermined direction, as shown in FIGS. 5 and 13-15.

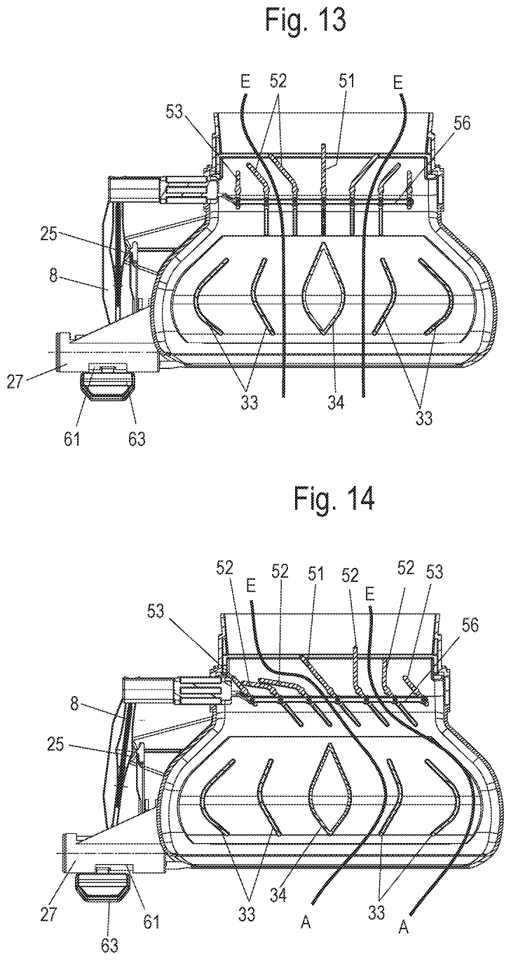

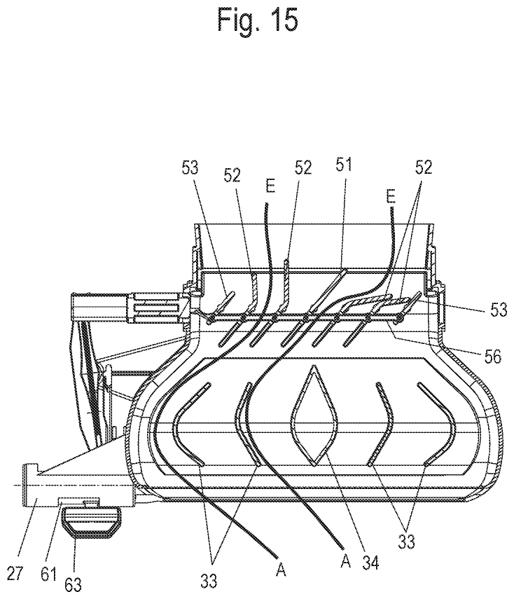

Depending on the setting of the slats 51, 52, 53 of the slat unit 5, which are arranged behind the guide unit 3, i.e., close to the inlet opening 23, an air flow, viewed in a horizontal plane, can thus pass the guide webs 33, 34 in a relatively straight line, as shown in FIG. 13, or be deflected by them, as can be seen in FIGS. 14 and 15.

In the case of slats 51, 52, 53 pivoted about a respective pivot axis 54 from a neutral position shown in FIG. 13, an air flow coming from the inlet opening 23 flows into the guide unit 3 at a predetermined angle after passing the slats 51, 52, 53. In the extreme case (with the slats 51, 52 53 pivoted to the maximum), only one half of the guide unit 3 is flowed through by the air flow, so that the outflow direction A takes place at an angle, in particular up to 40°, preferably up to 38°, relative to a central perpendicular of an imaginary plane of the outlet opening 24, due to the shape of the curved guide webs 33, 34 and of the side wall of the housing 2.

As can be further seen in FIG. 5, a central guide web 34 forming a perpendicular wall between the convexly curved guide surface 35 and an inner surface of the first housing part 21 or the second housing part 22 is preferably convexly curved.

In this case, the end facing the inlet opening 23 of this guide web 34, which is formed as a body convex on both sides, faces in the direction of a central slat 51 of the slat unit 5. The central slat 51 is formed as a flat surface, the front end of which is oriented in a neutral position of the slat 51 towards the rear tip of the guide web 34.

The guide webs 33, of which in the exemplary embodiment shown, for example in FIG. 13, in each case two protrude to the right and left of the guide web 34, which is designed as a convex body, from the convexly curved guide surface 35, are in each case designed as curved vertical surfaces, wherein the curvature of the guide web 33 near the guide web 34 is smaller than the curvature of a second guide web 33 arranged behind it. The guide webs 33 are in each case curved in such a way that, viewed relative to the central guide web 34, they are concavely curved.

Preferably, regions of the inner side walls 241 of the housing 2 close to the outlet opening 24 are also shaped such that the width of the inner space of the housing 2, viewed in a direction parallel to the first pivot axis S1, tapers towards the outlet opening 24. Preferably, the side inner walls 241 are shaped as concave curved guide surfaces.

In the assembled state, the edges of the guide webs 33, 34 remote from the curved guide surface 35 engage in receiving grooves 29 provided for this purpose in the first housing part 21 and the second housing part 22, respectively. It is also conceivable that the guide webs end at a predetermined distance from the inner walls of the housing parts 21, 22.

In an alternative embodiment variant not shown here, a central guide body 34 with convexly curved guide surfaces and guide webs 33, 34 with guide surfaces concavely curved to the guide body 34 protrude from inner surfaces of the housing 2 facing each other in the direction of the guide surfaces 35 of the guide unit 3.

The upper part 31 and the lower part 32 of the guide unit 3 are preferably formed symmetrically as a whole with respect to an imaginary horizontal central plane.

In the preferred embodiment variant shown here, a lighting unit 10 having a lighting element 101 is inserted in a cavity 36 below the convexly curved guide surface 35 of the upper part 31 or above a convexly curved guide surface 35 of the lower part 32, with which it is possible, depending on the temperature of the outflowing air flow, to make this visually identifiable by a color, for example red for warm air and blue for cold air.

Furthermore, by arranging the rigid guide unit 3 in the front area of the ventilation device 1 close to the outlet opening 24, a freer design of a front panel is possible.

The structure of the guide unit 3 in interaction with the control element 4 arranged therebehind and the slat unit 5 thus optionally allows air to be passed through all air ducts or optionally allows air to be passed exclusively through the guide air ducts formed with the guide webs 33, 34 of the upper part 31 of the guide unit 3 and the first housing part 21, which results in the air flow escaping downwards.

If the air duct body 41 of the control element 4 is appropriately oriented, an air discharge occurs exclusively through the guide air ducts formed by the guide surfaces 33, 34 of the lower part 32 of the guide unit 3 and of the second housing part 22, so that the outflow direction A of the air flow is directed upwards.

Accordingly, depending on the setting of the slats 51, 52, 53 of the slat unit 5, the air flow passes only through the guide air ducts to the right or to the left of the central guide web 34. By combining the setting of the slat unit 5 together with the air duct body 41 of the control element 4, it is also possible for the air to flow exclusively through one of the four quadrants of the guide unit 3 mentioned above.

The control element 4 and the slat unit 5 are shown in detail in FIGS. 7 and 8.

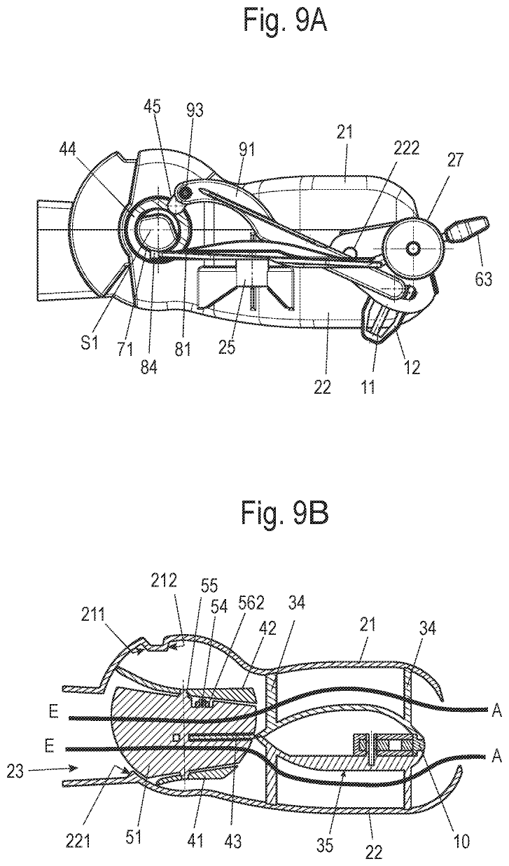

The air duct body 41 of the control element 4 is substantially of part-cylindrical shape and is rotatably mounted about an axis of rotation S1 (shown in FIG. 9A) in respective semi-cylindrical receiving bearings 26 of the first housing part 21 and the second housing part 22 of the housing 2.

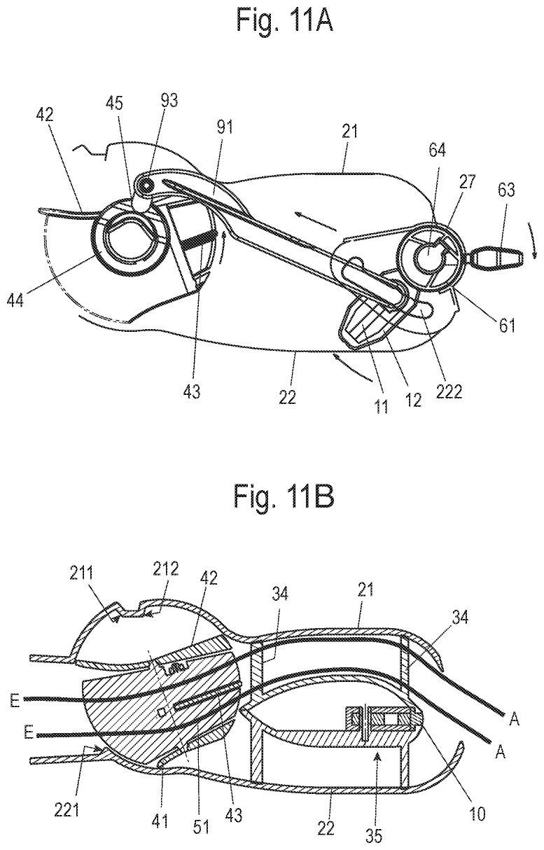

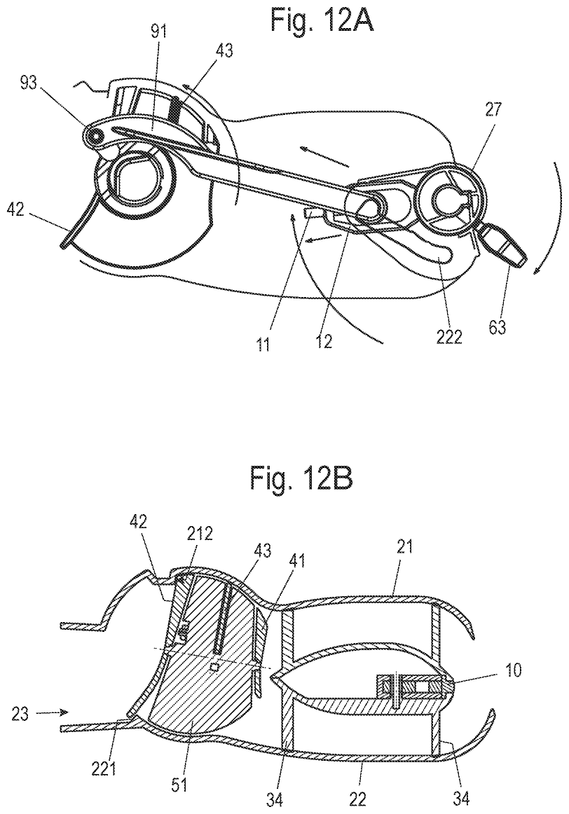

The air duct body 41 has a barrier wall 42 for blocking an air flow from the inlet opening 23 toward the guide unit 3, as exemplified in FIG. 12B.

As can be seen in FIG. 12B, in this position, edges of the barrier wall 42 extending in the longitudinal direction of the part-cylindrical air duct body 41 rest against respective stops 212, 221 integrally formed on the housing 2. The barrier wall 42 thereby forms a secant relative to the pivot point S1.

The slat unit 5 is inserted between a second wall of the air duct body 41, which is arranged at an acute angle to the barrier wall 42, and the barrier wall 42.

The slat unit 5 comprises a centrally arranged slat 51 with flat guide surfaces on both sides and at least one slat 52, 53 arranged laterally of the central slat 51 with angularly bent guide surfaces.

In a neutral position, as shown in FIG. 13, the bent slats 52, 53 are bent away from the central slat 51 in a rear area behind the second pivot axis 54 in the direction of flow.

If the slats 51, 52, 53 are in a position in which the air flow passing through the inlet opening 23 in the inflow direction E, as shown by way of example in FIG. 14, is folded down in such a way that the air flow passes only through the right-hand air ducts of the guide unit 3 in FIG. 14, the slats 52, 53 arranged to the left of the central slat 51 are correspondingly adjacent to one another in such a way that a flow through the left-hand guide air ducts of the guide unit 3 is blocked.

The curved design of the slats 52 makes it possible to block a guide air duct area of the guide unit 3 with a relatively small angle of adjustment of the slats 51, 52, 53.

The outer slat 53, which is relatively short compared to the slats 52 and 51, rests against a side inner wall of the air duct body 41 when folded down.

Each of the slats 51, 52, 53 has a pivot axis 54 by which they are pivotally held in corresponding bores in the air duct body 41. Furthermore, each of the slats 51, 52, 53 has a comb pin 55 onto which a slat comb 56 is fitted, with which it is possible to pivot all the slats 51, 52, 53 simultaneously about the pivot axes 54.

For further stabilization of the slats 51, 52, 53, a transverse groove is formed in a region of the slats 51, 52, 53 close to the guide unit 3, with which the slats 51, 52, 53 are fitted onto a guide surface 43 in the air duct body 41 of the control element 4. The guide surface 43 thereby divides the interior space of the air duct body 41 approximately in half when viewed in a direction perpendicular to the guide surface 43.

On the end face of the guide surface 43 facing away from the guide unit 3, receptacles 46 are provided for accommodating the pivot axes 54 of the slats 51, 52, 53.

While the slats 51, 52, 53 are pivotable about their pivot axes 54 within the air duct body 41 by means of the slat comb 56, the air duct body 41 itself is rotatable in the housing 2 about the first pivot axis S1, which is aligned perpendicular to the pivot axes 54 of the slats 51, 52, 53, in the housing 2 and thus enables a deflection of the air flow into the region of the first housing part 21 or into the region of the second housing part 22, while the pivoting of the slats 51, 52, 53 enables a deflection of an air flow into a left or right region of the guide unit 3 in FIG. 13.

To enable the air duct body 41 to rotate about the pivot axis S1, a coupling receptacle 44, which is cylindrical in shape here, is formed on the side of the air duct body 41 of the control element 4 on an end face of the air duct body 41.

On a front side of the coupling receptacle 44 facing away from the air duct body 41, a pin 45 is integrally formed eccentrically to the pivot axis S1, which is coupled to the adjusting unit 6 via an air duct body adjusting element 9.

A coupling element 7 is accommodated in the hollow cylindrical coupling receptacle 44 for adjusting the slats 51, 52, 53 via the slat comb 56, having a guide body 71 for axial displacement of the coupling element 7 in the coupling element receptacle 47 of the coupling receptacle 44.

The coupling element 7 is thereby accommodated in the coupling element receptacle 47 in a rotationally fixed but axially displaceable manner. A coupling element receptacle 73 is integrally formed on the coupling element 7 on its side close to the air duct body 41 in the state in which it is inserted into the coupling element receptacle 47, which coupling piece receptacle 73 serves for coupling with a coupling piece 563 at the end of the slat comb 56 formed as a rod 561 with receiving holes 562 for accommodating the comb pins 55 of the slats 51, 52, 53 and enables the slats 51, 52, 53 to be pivoted by axial displacement of the coupling element 7.

For axial displacement of the coupling element 7, a receiving groove 72 is provided at its end remote from the coupling piece receptacle 73, which groove extends perpendicularly to the longitudinal axis of the coupling element 7 and in which a pin 84 of a slat adjusting element 8 is accommodated, the first end 83 of which, spaced from the adjusting pin 84, is also coupled to the adjusting unit 6.

The adjusting unit 6 has an adjusting element 61 coupled to the slat adjusting element 8 and the air duct body adjusting element 9, for adjusting the air duct body 41 and the slat unit 5.

In the preferred embodiment variant shown here, the adjusting element 61 is formed as a hollow cylindrical body.

A preferred exemplary embodiment of an operating element 63 is arranged on the outer circumferential surface of the adjusting element 61, with which the adjusting element 61 can be both rotated about its central longitudinal axis and displaced in the direction of the central longitudinal axis. A spherical shape of the operating element 63 or other haptically suitable designs are also conceivable, for example.

In the embodiment variant shown here, the operating element 63 is fixed to the adjusting element 61 via a coupling element 62. The operating element 63 can be actuated in a simple manner by a finger of a person.

The coupling of the adjusting unit 6 with the slat unit 5 on the one hand and the air duct body 41 on the other hand is thereby intuitively designed in such a way that a displacement of the adjusting element 61 to the left is directed to a corresponding deflection to the left of an air flow emerging from the outlet opening 24 of the ventilation device 1. The same applies to a displacement of the adjusting element 61 to the right.

A rotation of the adjusting element 61 causes an upward adjustment of the outflow direction A of the airflow correspondingly, a downward rotation causes a downward deflection correspondingly.

Preferably, the coupling is further configured such that rotation of the adjusting element 61 to an even further downwardly rotated position causes blockage of the airflow, as illustrated in FIGS. 12a and 12b.

For adjusting the slats 51, 52, 53, the adjusting element 61 is provided on its side facing away from the operating element 63 with a groove aligned perpendicularly to the central longitudinal axis of the adjusting element 61 and in which the here preferably spherical first end 83 of the slat adjusting element 8 is received.

A web-like adjusting lever 81 between the first end 83 and the adjusting pin 84 comprises a bearing pin 82 mounted in a corresponding pivot bearing 25 on the second housing part 22 of the housing 2 so as to be rotatable about an axis of rotation which is vertical in this case, so that a movement of the adjusting element 61 to the left, as shown in FIG. 14, causes a displacement of the coupling element 7 to the right and thereby causes a pivoting of the slats 51, 52, 53 counterclockwise, so that an air flow entering through the inlet opening 23 in the inflow direction E, as shown in FIG. 14, is directed into the right-hand region of the guide unit 3, and is there deflected via the concavely curved guide webs 33 at a predetermined angle to a straight flow to the left.

The outflow angle is preferably in a range between 35° and 40°, particularly preferably about 38°.

FIG. 15 shows correspondingly a displacement of the adjusting element 61 to the right, which leads to a displacement of the coupling element 7 to the left and thereby the slats 51, 52, 53 are correspondingly pivoted clockwise by a predetermined angle, as a result of which a flow through the right-hand region of the guide unit 3 is blocked and the air flow flows exclusively through the left-hand region of the guide unit 3 and correspondingly leads to an outflow of the air flow in an outflow direction A correspondingly to the right through the concavely curved guide webs 33.

FIG. 13 accordingly shows an outflow direction perpendicular to an imaginary surface of the outlet opening 24, in which both the right and the left side of the guide unit 3 are equally flown through.

Referring to FIGS. 9A, 9B to 12A, 12B, the vertical adjustment of the air flow is described.

FIGS. 9a and 9b show the operating element 63 in a neutral rotational position in which, as can be readily seen in FIG. 9b, the barrier wall 42 and the wall of the air duct body 41 opposite thereto are aligned such that an air flow entering through the inlet opening 23 in the inflow direction E flows equally through the guide air ducts of the upper, first housing part 21 and the lower, second housing part 22.

For rotational actuation of the air duct body 41, the air duct body adjusting element 9 is coupled on the one hand to the pin 45 on the coupling receptacle 44 of the control element 4 via a pivot bearing 93 at a first end of an adjusting lever 91 of the air duct body adjusting element 9. The end of the adjusting lever 91 facing away from the pivot bearing 93 has a pin 92 which, on the one hand, is guided in a guide groove 222 on the second housing part 22 and projects into a pin receptacle 111 of a coupling element 11 which is displaceably accommodated in a guide bearing 122 of a coupling element 12.

Preferably, the air duct body 41 is pivotable through an angle of at least 110° about the first pivot axis S1.

The coupling element 12 further comprises a rod receptacle 121 through which a coupling rod 64 passes, which is guided through a central passage 67 of the adjusting element 61 and is held therein in a rotationally fixed manner. The coupling of the adjusting element 61 with the air duct body adjusting element 9 on the one hand and the slat adjusting element 8 on the other hand, as described above, enables the slat position of the slats 51, 52, 53 of the slats unit 5 and of the air duct body 41 to be adjusted independently of one another.

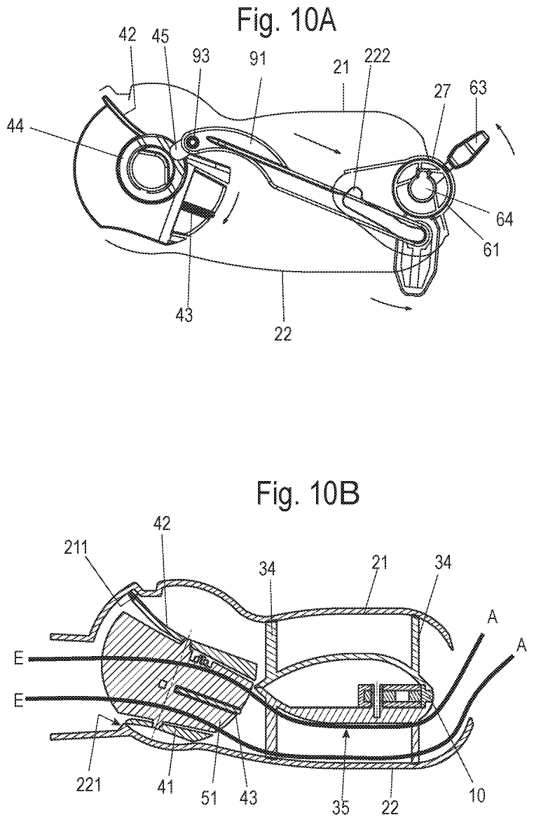

When the adjusting element 61 is rotated counterclockwise through a predetermined angle, as shown in FIG. 10A, so that the operating element 63 is rotated upward, this causes the air duct body 41 to rotate clockwise via the coupling with the air duct body adjusting element 9.

As shown in FIG. 10B, this rotation causes a blockage of the guide air ducts formed with the upper, first housing part 21, so that the air flow, as shown in FIG. 10B, flows exclusively through the guide air ducts in the area of the lower, second housing part 22 and thus leads to an upward outflow direction A from the outlet opening 24 of the housing 2.

FIGS. 11A and 11B accordingly show, upon movement of the operating element 63 downwardly through a predetermined angle, a rotation of the air duct body 41 from the neutral position to a counterclockwise position in which the guide air ducts in the lower region of the guide unit 3 are formed together with the lower, second housing part 22, so that the air flow is correspondingly directed through the upper guide air ducts, resulting in an outflow direction A downwardly.

FIGS. 12A and 12B finally show a blocking of the air flow, which is effected by pushing the operating element 63 downwards by a greater angle, which leads to a further rotation of the air duct body 41 so that the blocking surface 42 comes into contact with the stops 221 of the second housing part 22 and a stop 212 of the first housing part 21, thus completely closing the inlet opening 23 towards the guide unit 3.

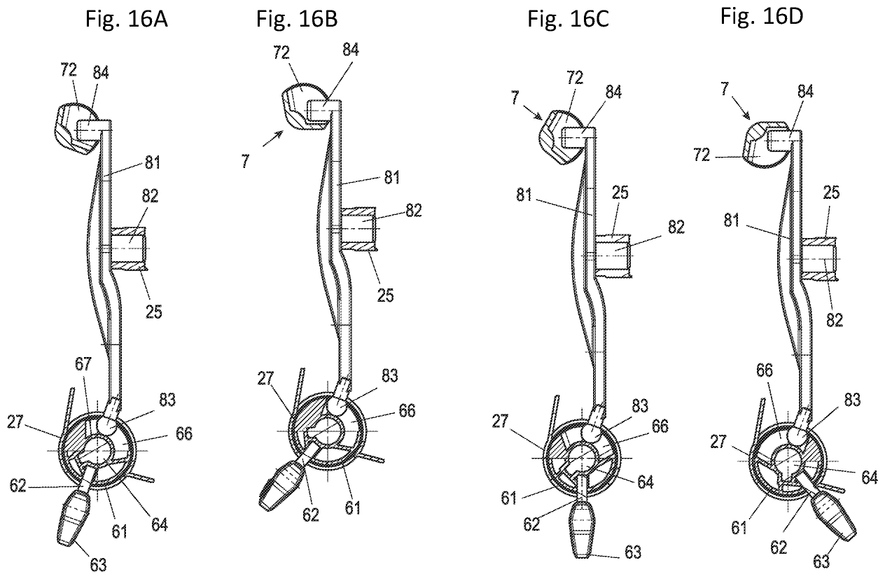

FIGS. 16A to 16D again illustrate that rotation of the adjusting element 61, which causes upward or downward deflection of the airflow, is possible without adjustment of the slats 51, 52, 53 by the slat adjusting element 8.

As shown in FIGS. 16A to 16D, the first end 83 of the slat adjusting element 8, which is spherical in shape here, is guided in a receiving groove 66 of the adjusting element 61, so that rotation of the adjusting element 61 does not affect the position of the slat adjusting element 8.

The same applies to the guidance of the adjusting pin 84 of the slat adjusting element 8 in the receiving groove 72 of the coupling element 7 provided for this purpose, which rotates accordingly when the air duct body 41 rotates, so that the length of the receiving groove 72 is correspondingly dimensioned such that a maximum permissible rotation of the air duct body 41 and with it of the coupling element 7 does not lead to jamming of the slat adjusting element 8.

The adjusting element 61, which is preferably cylindrical in shape, is thereby mounted laterally of the outlet opening on the housing 2 so as to be displaceable in the longitudinal direction of the cylinder and rotatable in the circumferential direction of the cylinder, preferably in a hollow cylindrical bearing 27 which is integrally formed laterally on the second housing part 22 and comprises a window 28 from which the operating element 63 of the adjusting element 6 projects.

It is also conceivable that the slat unit 5 and the control element 4 are electromechanically operable via one or more drive motors, which are preferably directly coupled to the slat unit 5 and the control element.

In this exemplary embodiment, the electromechanical adjusting unit 6 is electrically coupled to the motor(s) to control the motor(s). It is also conceivable to design the adjusting unit as a touchscreen or also as an acoustic or optical unit in order to control the actuation of the motor or motors by voice input or gestures.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Ventilation device
2 Housing
21 First housing part
211 First stop
212 Second stop
22 Second housing part
221 Stop
222 Guide groove
23 Inlet opening
24 Outlet opening
241 Inner side wall
25 Pivot bearing
26 Bearing
27 Bearing
28 Window
29 Receiving groove
3 Guide unit
31 Upper part
32 Lower part
33 Guide web
34 Guide body
35 Guide surface
36 Receiving space
37 Connecting element
4 Control element
41 Air duct body
42 Barrier wall
43 Guide surface
44 Coupling receptacle
45 Pin
46 Slat receptacle
47 Coupling element receptacle
5 Slat unit
51 Slat
52 Slat
53 Slat
54 Pivot axis
55 Comb pin
56 Slat comb
561 Rod
562 Receiving hole
563 Coupling piece
6 Adjusting unit
61 Adjusting element
62 Coupling element
63 Operating element
64 Coupling rod
65 Cover
66 Receiving groove
67 Passage
7 Coupling element
71 Guide body
72 Receiving groove
73 Coupling piece receptacle
8 Slat adjusting element
81 Adjustment lever
82 Bearing pin
83 First end
84 Adjusting pin
9 Air duct body adjusting element
91 Adjusting lever
92 Pin
93 Pivot bearing
10 Lighting unit
101 Lighting element
11 Coupling element
111 Pin receptacle
112 Guide web
12 Coupling element
121 Rod receptacle
122 Guide bearing
123 Web receptacle
A Outflow direction
E Inflow direction
S1 First pivot axis
L Air flow

1. A ventilation device of a motor vehicle for regulating or changing an outflow direction of air exiting the ventilation device, the ventilation device comprising:
a housing having an air inlet with at least one inlet opening and an air outlet having at least one outlet opening open towards a passenger compartment of the motor vehicle;
a guide unit arranged between the at least one inlet opening and the at least one outlet opening in the housing, wherein the guide unit, together with a section of the housing surrounding the guide unit, forms a plurality of curved air ducts;
a control element arranged between the at least one inlet opening and the guide unit in the housing, wherein the control unit is configured to adjust a volumetric flow ratio of an air flow flowing along the guide unit, wherein the control element comprises a partially cylindrical air duct body arranged in the housing so as to be pivotable about a first pivot axis perpendicular to an inflow direction;
an adjusting unit configured to adjust the control element; and
a slat unit is arranged in the partially cylindrical air duct body, wherein the slat unit includes a plurality of slats arranged next to one another as viewed in the inflow direction, wherein the plurality of slats are coupled to one another and are pivotable about respective second pivot axes perpendicular to the first pivot axis,
wherein the partially cylindrical air duct body and the slat unit are adjustable independently of each other by actuating the adjusting unit.

2. The ventilation device of claim 1, wherein regions of inner side walls of the housing close to the at least one outlet opening are shaped in such a way that a width of an inner space of the housing tapers towards the at least one outlet opening.

3. The ventilation device of claim 2, wherein the regions of the inner side wall of the housing close to the at least one outlet opening are shaped as concavely curved guide surfaces.

4. The ventilation device of claim 1, wherein the partially cylindrical air duct body comprises a barrier wall configured to block the air flow from the at least one inlet opening towards the guide unit.

5. The ventilation device of claim 1, wherein the slat unit has a centrally arranged slat with flat guide surfaces on both sides and at least one slat arranged laterally of both sides of the centrally arranged slat, wherein the at least one slat arranged laterally of both sides of the centrally arranged slat have angularly bent guide surfaces that are bent away from the centrally arranged slat in a neutral position in a rear region behind the second pivot axis in a direction of the air flow.

6. The ventilation device of claim 1, the adjusting unit is an electromechanical adjusting unit.

7. The ventilation device of claim 6, wherein the adjusting unit is a touchscreen, acoustic unit, or optical unit coupled to at least one servomotor driving the slat unit or the partially cylindrical air duct body.

8. The ventilation device of claim 1, wherein the adjusting unit is coupled to the partially cylindrical air duct body via an air duct body adjusting element, wherein the air duct body adjusting element is configured to adjust the partially cylindrical air duct body pivotably about the first pivot axis.

9. The ventilation device of claim 1, wherein the adjusting unit is coupled to the slat unit via a slat adjusting element, wherein the slat adjusting element is configured to adjust the slat unit so as to be pivotable about the second pivot axis.

10. The ventilation device of claim 9, wherein the adjusting unit comprises an adjusting element coupled to the slat adjusting element and the air duct body adjusting element for adjusting the air duct body and the slat unit.

11. The ventilation device of claim 10, wherein the adjusting element is cylindrical, displaceable in a longitudinal direction of the cylinder at a side of the at least one outlet opening on the housing, and mounted rotatably in a circumferential direction of the cylinder.

12. The ventilation device of claim 11, wherein the adjusting unit has an operating element fixed to the adjusting element.

13. The ventilation device of claim 1, wherein the guide unit is formed in several parts.

14. The ventilation device of claim 13, wherein the guide unit has an upper part and a lower part, each with guide webs projecting in a direction of the housing from a convexly curved guide surface.

15. The ventilation device of claim 14, wherein a central guide body with convexly curved guide surfaces projects from each of the upper part and the lower part of the guide unit in the direction of the housing.

16. The ventilation device of claim 1, further comprising:
a central guide body with convexly curved guide surfaces and guide webs with guide surfaces concavely curved towards the guide body project from mutually facing inner surfaces of the housing in a direction of the guide surfaces of the guide unit.

17. The ventilation device of claim 15, further comprising:
a lighting unit fixed in a cavity formed between the upper part and the lower part of the guide unit.
